(19) United States
(12) Patent Application Publication
(10) Pub. No.: US 2020/0142027 A1
(43) Pub. Date: May 7, 2020

(54) APPARATUS AND METHOD FOR CALIBRATING A ZERO POINT OF A RADAR FOR A VEHICLE

(71) Applicants: HYUNDAI MOTOR COMPANY, Seoul (KR); KIA MOTORS CORPORATION, Seoul (KR)

(72) Inventor: Jong Hyuck LEE, Hwaseong-si (KR)

(73) Assignees: HYUNDAI MOTOR COMPANY, Seoul (KR); KIA MOTORS CORPORATION, Seoul (KR)

(21) Appl. No.: 16/299,703

(22) Filed: Mar. 12, 2019

(30) Foreign Application Priority Data
Nov. 2, 2018 (KR) 10-2018-0133405

(51) Int. Cl. G01S 7/40; G01S 13/93

(52) U.S. Cl. CPC G01S 7/4021; G01S 2007/4078; G01S 7/4052; G01S 13/931

(57) ABSTRACT

An apparatus and a method for calibrating a zero point of a radar for a vehicle are provided. A horizontal angle shift, a vertical angle shift, and a rotational angle shift of the radar for the vehicle are corrected based on angles (a horizontal angle, a vertical angle, and a rotation angle) formed with a first reference reflector and angles (a horizontal angle, a vertical angle, and a rotational angle) formed with a second reference reflector, thereby calibrating the zero point of the radar for the vehicle with higher accuracy.

### CROSS-REFERENCE TO RELATED APPLICATION

This application claims priority to and the benefit of Korean Patent Application No. 10-2018-0133405, filed on Nov. 2, 2018, the entire contents of which are incorporated herein by reference.

### FIELD

The present disclosure relates to an apparatus and a method for calibrating a zero point of a radar for a vehicle.

### BACKGROUND

The statements in this section merely provide background information related to the present disclosure and may not constitute prior art.

In general, a radar for a vehicle detects a distance from an advancing vehicle and transmits a signal when the advancing vehicle is at a specific distance or less. Alternatively, the radar transmits the signal when an object approaches a specific distance or less from the front portion of the bumper during parking, thereby calling the attention of a driver to prevent collision accident.

The radar for the vehicle has to perform a zero point calibration procedure (zeroing) to allow a driver to exactly pay attention ahead.

We have discovered that a conventional technology of calibrating the zero point of the radar for a vehicle is to adjust only a vertical position and a horizontal position of the radar for the vehicle and not a horizontal angle and a vertical angle of the radar for the vehicle.

In other words, according to the conventional technology of calibrating the zero point, since the zero point calibration procedure is performed using one reflector, the shift (horizontal shift, vertical shift, and rotation shift) of the radar for the vehicle may not be detected, so the zero point of the radar for the vehicle may not be exactly calibrated.

### SUMMARY

The present disclosure has been made to address the above-mentioned problems occurring in the prior art while advantages achieved by the prior art are maintained intact.

An aspect of the present disclosure provides an apparatus and a method for calibrating a zero point of a radar for a vehicle with high accuracy, by correcting a horizontal angle shift, a vertical angle shift, and a rotational angle shift of the radar for the vehicle, based on angles (a horizontal angle, a vertical angle, and a rotational angle) formed with a first reference reflector and angles (a horizontal angle, a vertical angle, and a rotational angle) formed with a second reference reflector.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for calibrating a zero point of a radar for a vehicle includes: a driver configured to adjust an angle of the radar; and a controller configured to obtain a first angle formed between the radar and a first reference reflector and to obtain a second angle formed between the radar and a second reference reflector, and configured to control the driver to match the first angle with a first reference angle, and to match the second angle with a second reference angle.

According to the present disclosure, the apparatus further include storage configured to store a first reference angle formed between the radar and the first reference reflector, and to store a second reference angle formed between the radar and the second reference reflector.

In this case, the controller may control the driver to adjust at least one of a horizontal angle, a vertical angle, or a rotational angle of the radar. In this case, the driver may include at least one of a first driver to adjust the horizontal angle, a second driver to adjust the vertical angle, and a third driver to adjust the rotational angle.

In addition, the first reference angle may include a first horizontal reference angle, a first vertical reference angle, and a rotational reference angle, where the second reference angle may include a second horizontal reference angle, a second vertical reference angle, and the rotational reference angle.

Accordingly, the controller may calibrate a zero point of the radar by matching a first horizontal angle with the first horizontal reference angle and matching a second horizontal angle with the second horizontal reference angle, when the first angle is the first horizontal angle, and the second angle is the second horizontal angle.

Accordingly, the controller may calibrate the zero point of the radar by matching a first vertical angle with the first vertical reference angle and a second vertical angle with the second vertical reference angle, when the first angle is the first vertical angle, and the second angle is the second vertical angle.

In addition, the controller may calibrate the zero point of the radar by matching rotational angles with the rotational reference angle, when the first angle and the second angle are the rotational angles.

According to an aspect of the present disclosure, a method for calibrating a zero point of a radar for a vehicle includes: obtaining, by a controller, a first angle formed between the radar and the first reference reflector; obtaining, by the controller, a second angle formed between the radar and a second reference reflector; and matching, by the controller, the first angle with the first reference angle and the second angle with the second reference angle.

According to the present disclosure, the method may further include storing, by storage, the first reference angle formed between the radar and the first reference reflector, and the second reference angle formed between the radar and the second reference reflector.

In this case, the method may further include adjusting, by the controller, at least one of a horizontal angle, a vertical angle, or a rotational angle of the radar.

In addition, the first reference angle may include a first horizontal reference angle, a first vertical reference angle, and a rotational reference angle, and the second reference angle may include a second horizontal reference angle, a second vertical reference angle, and the rotational reference angle,

Accordingly, in the matching, the zero point of the radar may be calibrated by matching a first horizontal angle with the first horizontal reference angle and a second horizontal angle with the second horizontal reference angle, when the first angle is the first horizontal angle, and the second angle is the second horizontal angle.

Accordingly, in the matching, the zero point of the radar may be calibrated by matching a first vertical angle with the first vertical reference angle and a second vertical angle with the second vertical reference angle, when the first angle is the first vertical angle, and the second angle is the second vertical angle.

In addition, in the matching, the zero point of the radar may be calibrated by matching rotational angles with the rotational reference angle, when the first angle and the second angle are the rotational angles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a structure of an apparatus for calibrating a zero point of a radar for a vehicle;

FIG. 2 is a view illustrating the structure of the radar;

FIG. 3 is a view illustrating a horizontal angle of the radar for the vehicle;

FIG. 4 is a view illustrating a vertical angle of the radar for the vehicle;

FIG. 5 is a view illustrating a rotational angle of the radar for the vehicle; and

FIG. 6 is a flowchart illustrating a method for calibrating a zero point of a radar for a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, in the following description, a detailed description of well-known features or functions will be ruled out in order not to unnecessarily obscure the gist of the present disclosure.

In describing elements of exemplary forms of the present disclosure, the terms 1st, 2nd, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific tams, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

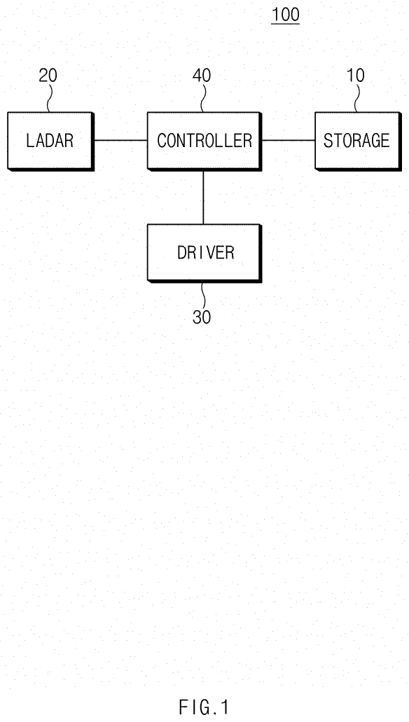

FIG. 1 is a block diagram illustrating the structure of an apparatus for calibrating a zero point of the radar for a vehicle, according to one form of the present disclosure.

As illustrated in FIG. 1, an apparatus 100 for calibrating a zero point of a radar for a vehicle may include: a storage 10, a radar 20, a driver 30, and a controller 40. Meanwhile, depending on a scheme of reproducing the apparatus 100 for calibrating the zero point of the radar for the vehicle, components are coupled to each other to be unified in one component. In addition, some components may be omitted depending on the scheme of reproducing the present disclosure.

Regarding the components, first, the storage 10 stores a reference angle formed between the radar 20 and a first reference reflector 210 and a reference angle formed between the radar 20 and a second reference reflector 220. In this case, the reference angle formed between the radar 20 and the first reference reflector 210 may be an incident angle of a laser beam output from the radar 20 and reflected from the first reference reflector 210. The reference angle formed between the radar 20 and the second reference reflector 230 may be an incident angle of a laser beam output from the radar 20 and reflected from the second reference reflector 230. In this case, the reference angles may include horizontal reference angles (θᵣ₁ and θᵣ₂), vertical reference angles (θᵣ₃ and θᵣ₄), and the rotational reference angle (θᵣ₅).

In addition, the storage 10 may store various logics, various algorithms, and various programs desired to correct a horizontal angle shift, a vertical angle shift, and a rotational angle shift of the radar for the vehicle, based on angles (a horizontal angle, a vertical angle, and a rotational angle) formed with the first reference reflector 210 and angles (a horizontal angle, a vertical angle, and a rotational angle) formed with the second reference reflector 220.

The storage 130 may include a storage medium including at least one of a flash memory type memory, a hard disk type memory, a micro type memory, a card type memory (security digital (SD) card or an eXtream digital card), a Random Access Memory (RAM), a Static Random Access Memory (SRAM), a Read Only Memory (ROM), a Programmable Read Only Memory (PROM), an Electrically Erasable and Programmable ROM (EEPROM), a magnetic RAM, a magnetic disk, and optical disk type memory.

The radar 20 is mounted in the vehicle to detect an object.

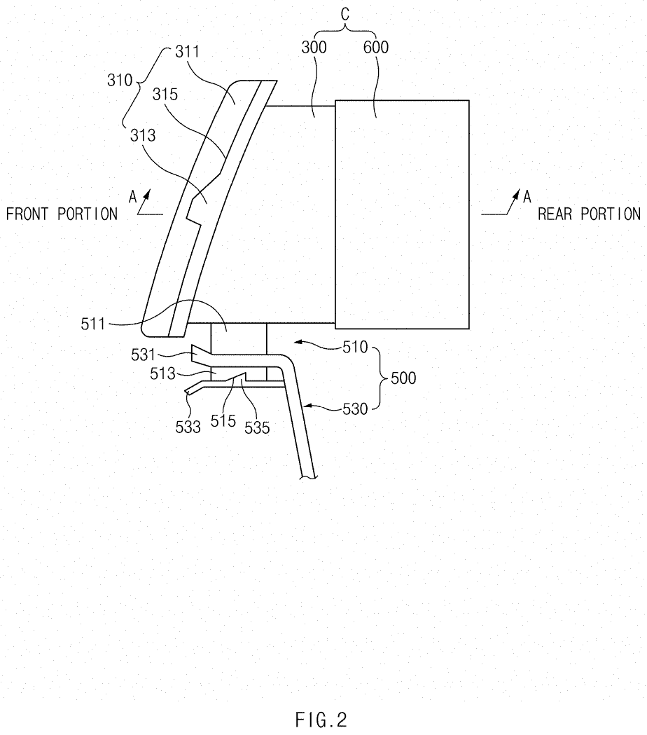

For example, the radar 20 may include a radar module 600 provided inside a radiator grill (GR) of a vehicle, a multiple-layer transmission cover 300 fitted into the radar module 600 and formed on the front surface thereof with a plurality of transmission layers 310 for transmitting a laser beam radiated through the radar module 600, and a mounting part 500 to couple an assembly C to a vehicle body as the multiple-transmission cover 300 is assembled with the radar module 600, as illustrated in FIG. 2.

The radar module 600 is disposed toward a front portion of a vehicle, the multiple-layer transmission cover 300 is formed in the shape of a cover to cover the entire surface of the radar module 70. The transmission layer 310 of the multiple-layer transmission cover 300 includes a transparent resin layer 311 formed at the outermost part of the multiple-layer transmission cover 300, a base 313 making the thickness of the transparent resin layer 311 uniform, and a metallic layer 315 having the same metallic effect as the outer appearance of the radiator grill (RG). The metallic layer 315 is positioned between the transparent resin layer 311 and the base 313 to produce the same metallic effect as that of the radiator grill (RG).

A coupling hole (not illustrated) is formed in the central portion of the radiator grill (RG), and the radar is coupled to the coupling hole. Accordingly, the transmission layer 310 of the multiple-layer transmission cover 300 is inclined at an angle widened downward and formed on the same plane as the radiator grill (RG). Since the multiple-layer transmission cover 300 has the shape of a cover to completely seal the radar module 600, foreign matters, such as water or dust, may be prevented from being introduced into the radar module 600.

Since a radome is removed from the front surface of the radar module 600, and the multiple-layer transmission cover is coupled to the radiator grill (RG), the number of transmission layers for transmitting the radar beam is reduced, thereby reducing the interference between the radar beam and parts. In addition, the radome is removed to simplify the structure is simplified, thereby reduce the space configured, and the weight of the vehicle is reduced, thereby reducing raw material costs. Further, since the transmission layer is directly formed on the radiator grill which is the outermost part of the vehicle, the size of the radar beam transmission cover may be reduced, and the aesthetics of the vehicle may be improved.

The mounting part to fix the assembly C made by assembling the radar module 600 and the multi-layer transmission cover 300 together to the vehicle body includes a support part 510 and a guide part 530. The support part 510 includes a support bar 511 vertically extending downward from the lower surface of the assembly C and a sliding bar 513 provided on the lower surface of the support bar 511 and extending in a left-right direction of a vehicle. The guide part 530 extends perpendicularly to the vehicle body, has an upper end bent toward the front surface, and includes opposite grip parts 531 formed as the bending part is divided into a plurality of parts to fix the support bar 511, and a central sliding part 533 to fix the sliding par 513. In this case, the support part 510 may include one or a plurality of parts, and may be formed on the lower surface of the multi-layer transmission cover 300 or the lower surface of the radar module 600.

The support bar 511, which extends in the vertical direction, and the sliding bar 513, which is formed on the lower surface of the support bar 511 perpendicularly to the support bar 511 and has a thickness in a left-right direction of the vehicle, form a sectional-surface having the inverse T shape, thereby more strongly and stably assembling the assembly C with the vehicle body.

The sliding bar 513 is formed in the lower surface thereof with a locking groove 515 inwardly recessed to be deepened from the front portion of the vehicle toward the rear portion of the vehicle, and is formed on an upper surface thereof with a locking protrusion 535 provided in the form of an inclined surface gradually heightened from the front portion of the vehicle toward the rear portion of the vehicle.

Accordingly, when the assembly is fixed to the vehicle body, the assembly is pushed from the front portion of the vehicle to be assembled such that the locking groove 515 of the sliding bar 513 is locked around the locking protrusion 535 of the sliding part 533. Accordingly, the assembling is easy and simple and the coupling is always made at the same position. Therefore, the performance of the radar is improved, and the risk such as assembling failure may be reduced.

In addition, since the locking protrusion 535 of the sliding part 533 is provided in the form of an inclined surface which is gradually heightened from the front portion of the vehicle toward the rear portion of the vehicle, when the head-on collision of the vehicle occurs, the force, which allows the locking groove 515 to cross over the locking protrusion 535, is generated so that the locking groove 515 slides along the top surface of the locking protrusion 535. Accordingly, the sliding bar 513 of the assembly C is separated toward the rear portion of the vehicle through the sliding part 533, thereby reducing the repair cost of the high-priced radar.

The driver 30 is a motor that adjusts the horizontal angle, vertical angle, and a rotational angle of the radar 20, and includes a motor to adjust the horizontal angle, a motor to adjust the vertical angle and a motor to adjust the rotational angle, according to forms.

The controller 40 performs the overall control such that the components normally perform the respective functions. In addition, the controller 40 may be implemented in the form of hardware or software, and may be present in the form of the combination of the hardware and the software. In one form, the controller 40 may be implemented in the form of a micro-processor, but the present disclosure is not limited thereto.

The controller 40 performs the overall control in the process of correcting the horizontal angle shift, the vertical angle shift, and the rotational angle shift of the radar for the vehicle, based on angles (a horizontal angle, a vertical angle, and a rotational angle) formed with the first reference reflector 210 and angles (a horizontal angle, a vertical angle, and a rotational angle) formed with the second reference reflector 220.

The controller 40 obtains the angles (a horizontal angle, a vertical angle, and a rotational angle) formed with the first reference reflector 210 and the angles (a horizontal angle, a vertical angle, and a rotational angle) formed with the second reference reflector 220.

The controller 40 corrects the angles formed with the first reference reflector 210 and the angles formed with the second reference reflector 220, based on horizontal reference angles (θᵣ₁), vertical reference angles (θᵣ₃) and rotation reference angles (θᵣ₅), which are formed between the radar 20 and the first reference reflector 210 and horizontal reference angles (θᵣ₂), vertical reference angles (θᵣ₄), and rotation reference angles (θᵣ₅) which are formed between the radar 20 and the second reference reflector 220, which are stored in the storage 10.

In other words, the controller 40 matches the horizontal angle (hereinafter, referred to as “the first horizontal angle”), the vertical angle (hereinafter, referred to as “the first vertical angle), and the rotational angle, which are formed with the first reference reflector 210, with horizontal reference angle (θᵣ₁), the vertical reference angle (θᵣ₃), and the rotation reference angle (θᵣ₅), and matches the horizontal angle (hereinafter, referred to as “the second horizontal angle”), the vertical angle (hereinafter, referred to as “the second vertical angle), and the rotational angle, which are formed with the second reference reflector 220, with horizontal reference angle (θᵣ₂), the vertical reference angle (θᵣ₄), and the rotation reference angle (θᵣ₅) In this case, when the radar 20 is not rolled, the difference between the first horizontal angle and the horizontal reference angle (θᵣ₁) is equal to the difference between the second horizontal angle and the horizontal reference angle (θᵣ₂), and the difference between the first vertical angle and the vertical reference angle (θᵣ₃) is equal to the difference between the second vertical angle and the vertical reference angle (θᵣ₄).

When the controller 40 may match the first horizontal angle, the vertical angle, and the rotational angle with the horizontal reference angle (θᵣ₁), the vertical reference angle (θᵣ₃), and the rotation reference angle (θᵣ₅), respectively, may match the second horizontal angle, the second vertical angle, and the rotational angle with the horizontal reference angle (θᵣ₂), the vertical reference angle (θᵣ₄), and the rotational reference angle (θᵣ₅), respectively. In one form, the matching may be simultaneously matched by using well-known technologies, or the horizontal angle and the vertical angle may matched after the rotational angle is matched. In this case, the sequence of the horizontal angle and the vertical angle do not exert any influence on the present disclosure.

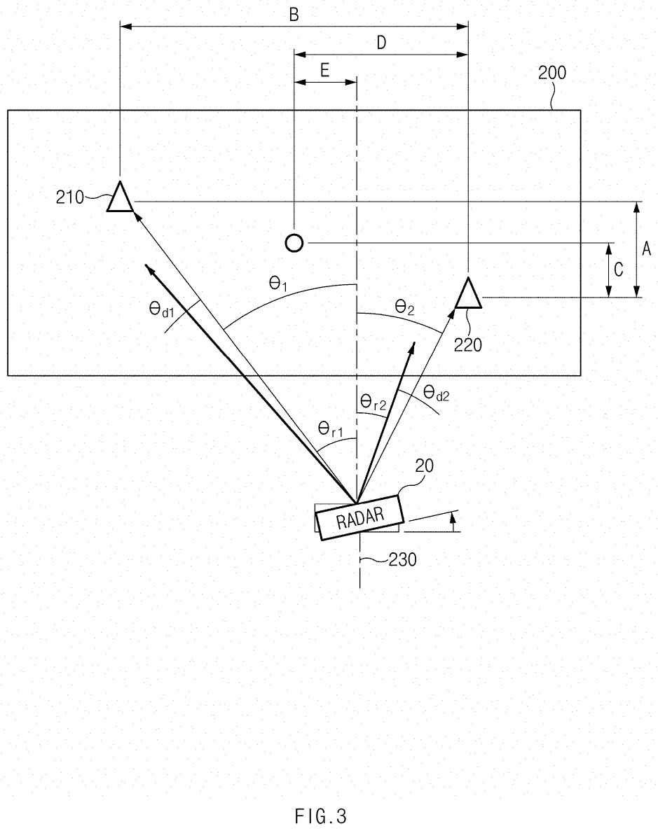

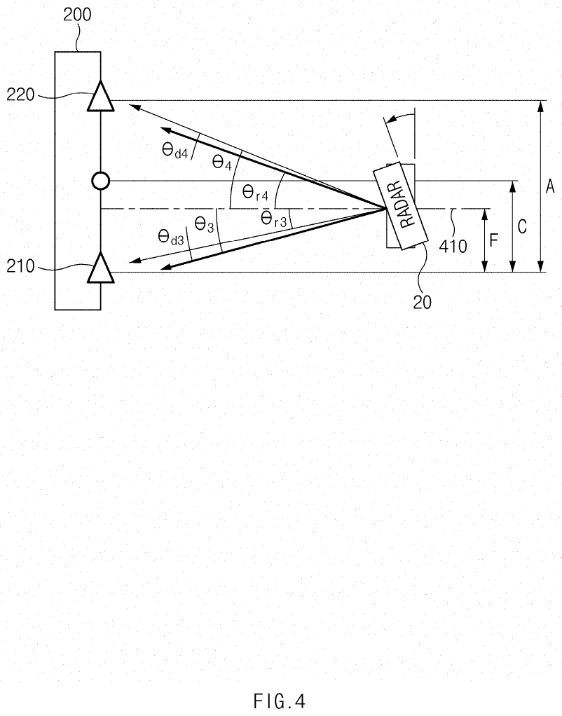

Hereinafter, the horizontal angle, the vertical angle, and the rotational angle will be described in detail with reference to FIGS. 3 and 4.

FIG. 3 is a view illustrating a horizontal angle of the radar for the vehicle, according to an exemplary form of the present disclosure.

In FIG. 3, for easier explanation of the horizontal angle of the radar for the vehicle, a rectangular flat board 200 including the first reference reflector 210 and the second reference reflector 220 is illustrated in a front view, and the radar 20 is illustrated in a plan view. In this case, when the position of the first reference reflector 210 and the position of the second reference reflector 220 are fixed, the vehicle width is 2 m, and the vehicle height is 1.7 m. In one form, “A” may be 500 mm or more, and “B” may be 700 mm or more. In addition, since an absorber is attached onto the rectangular flat board 200, reflectance may be lowered in a remaining area other than the first reference reflector 210 and the second reference reflector 220.

Based on the central line 230 of the radar 20, θᵣ₁ refers to the horizontal reference angle formed with the first reference reflector 210, θ₁ represents the horizontal angle of the radar 20 actually measured, θᵣ₂ represents the horizontal reference angle formed with the second reference reflector 220, and θ₂ represents the horizontal angle of the radar 20 actually measured. Accordingly, θ_{d1} refers to θ₁-θᵣ₁, and θ_{d2} refers to θ₂-θᵣ₂. In this case, when the radar 20 is not rolled, θ_{d1} and θ_{d2} have an equal value.

In addition, since the position of the first reference reflector 210 and the position of the second reference reflector 220 are fixed, ‘A’, ‘B’, ‘C’, ‘D’, and ‘E’ have fixed values.

FIG. 4 is a view illustrating a vertical angle of the radar for the vehicle, according to one form of the present disclosure.

As illustrated in FIG. 4, based on the central line 410 of the radar 20, θᵣ₃ refers to the vertical reference angle formed with the first reference reflector 210, θ₃ represents the vertical angle of the radar 20 actually measured, θᵣ₄ represents the vertical reference angle formed with the second reference reflector 220, and θ₄ represents the vertical angle of the radar 20 actually measured. Accordingly, θ_{d3} refers to θ₃-θᵣ₃, and θ_{d4} refers to θ₄-θᵣ₄. In this case, when the radar 20 is not rolled, θ_{d3} and θ_{d4} have an equal value.

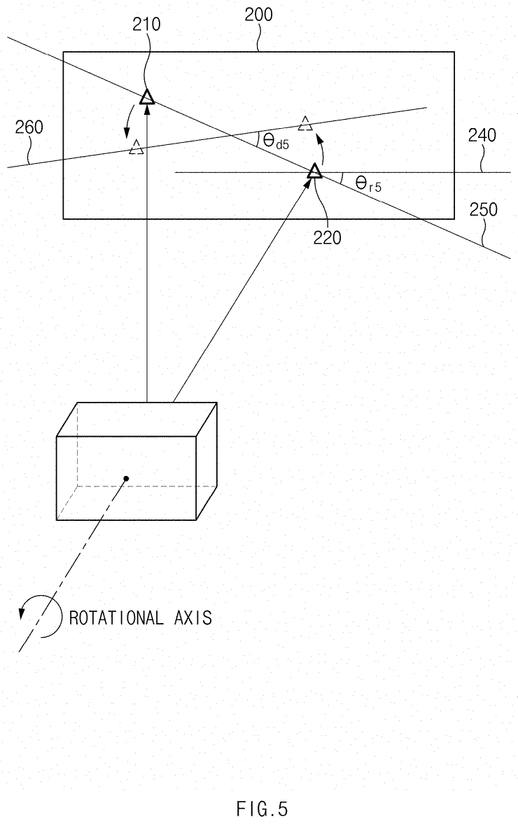

FIG. 5 is a view illustrating a rotational angle of the radar for the vehicle, according to an exemplary form of the present disclosure.

As illustrated in FIG. 5, when the radar 20 is rolled about the rotational axis, the first straight line 250 passing the first reference reflector 210 and the second reference reflector 220 is changed to the second straight line 260. In this case, θᵣ₅ represents the rotational reference angle between the first straight line 250 and the reference line 240, and θ_{d5} represents an angle between the first straight line 250 and the second straight line 260.

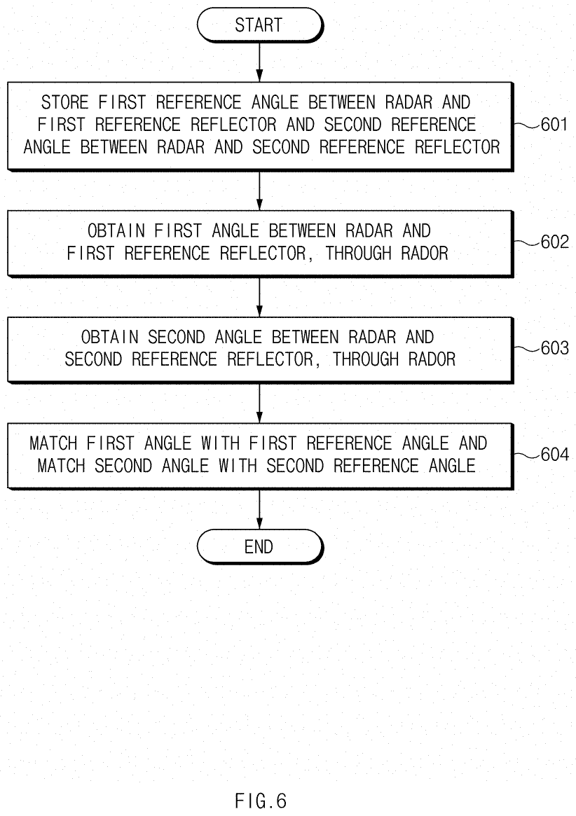

FIG. 6 is a flowchart illustrating a method for calibrating a zero point of a radar for a vehicle, according to another form of the present disclosure.

First, the first reference angle formed between the radar 20 and the first reference reflector 210, and the second reference angle formed between the radar 20 and the second reference reflector 220 are stored (601).

Thereafter, the first angle between the radar 20 and the first reference reflector 210 is obtained through the radar 20 (602).

Thereafter, the second angle between the radar 20 and the second reference reflector 220 is obtained through the radar 20 (603).

Thereafter, the first angle, which is obtained, is matched with the first reference angle, and the second angle, which is obtained, is matched with the second reference angle, thereby calibrating the zero point of the radar 20.

Through this procedure, the zero-point (the horizontal angle, the vertical angle, and the rotational angle) of the radar 20 may be accurately calibrated.

As described above, according to one form of the present disclosure, in the apparatus and the method for calibrating the zero point of the radar for the vehicle, the horizontal angle shift, the vertical angle shift, and the rotational angle shift are corrected based on the angles (the horizontal angle, the vertical angle, and the rotational angle) formed with the first reference reflector and the angles (the horizontal angle, the vertical angle, and the rotational angle) formed with the second reference reflector, thereby calibrating the zero point of the radar for the vehicle with the higher accuracy.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, the exemplary forms of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. An apparatus for calibrating a zero point of a radar for a vehicle, the apparatus comprising:
a driver configured to adjust an angle of the radar; and
a controller configured to:
obtain a first angle formed between the radar and a first reference reflector, and to obtain a second angle formed between the radar and a second reference reflector; and
control the driver to match the first angle with a first reference angle, and to match the second angle with a second reference angle.

2. The apparatus of claim 1, further comprising:
storage configured to store the first reference angle formed between the radar and the first reference reflector, and to store the second reference angle formed between the radar and the second reference reflector.

3. The apparatus of claim 1, wherein the controller is configured to control the driver to adjust at least one of a horizontal angle, a vertical angle, or a rotational angle of the radar.

4. The apparatus of claim 3, wherein the driver includes:
at least one of a first driver configured to adjust the horizontal angle, a second driver configured to adjust the vertical angle, or a third driver configured to adjust the rotational angle.

5. The apparatus of claim 3, wherein the first reference angle includes a first horizontal reference angle, a first vertical reference angle, and a rotational reference angle, wherein the second reference angle includes a second horizontal reference angle, a second vertical reference angle, and the rotational reference angle.

6. The apparatus of claim 5, wherein the controller is configured to:
match a first horizontal angle with the first horizontal reference angle and a second horizontal angle with the second horizontal reference angle, when the first angle is the first horizontal angle, and the second angle is the second horizontal angle.

7. The apparatus of claim 5, wherein the controller is configured to:
match a first vertical angle with the first vertical reference angle and a second vertical angle with the second vertical reference angle, when the first angle is the first vertical angle, and the second angle is the second vertical angle.

8. The apparatus of claim 5, wherein the controller is configured to:
match rotational angles with the rotational reference angle, when the first angle and the second angle are the rotational angles.

9. The apparatus of claim 1, wherein the first reference reflector and the second reference reflector have a vertical distance of 500 mm or more and a horizontal distance of 700 mm or more between the first reference reflector and the second reference reflector, on the same plane.

10. A method for calibrating a zero point of a radar for a vehicle, the method comprising:
obtaining, by a controller, a first angle formed between the radar and a first reference reflector;
obtaining, by the controller, a second angle formed between the radar and a second reference reflector; and
matching, by the controller, the first angle with a first reference angle and the second angle with a second reference angle.

11. The method of claim 10, further comprising:
storing, by storage, the first reference angle formed between the radar and the first reference reflector, and the second reference angle formed between the radar and the second reference reflector.

12. The method of claim 10, further comprising:
adjusting, by the controller, at least one of a horizontal angle, a vertical angle, or a rotational angle of the radar.

13. The method of claim 12, wherein the first reference angle includes a first horizontal reference angle, a first vertical reference angle, and a rotational reference angle, and
wherein the second reference angle includes a second horizontal reference angle, a second vertical reference angle, and the rotational reference angle.

14. The method of claim 13, wherein the matching includes:
matching a first horizontal angle with the first horizontal reference angle, and matching a second horizontal angle with the second horizontal reference angle, when the first angle is the first horizontal angle, and the second angle is the second horizontal angle.

15. The method of claim 13, wherein the matching includes:
matching a first vertical angle with the first vertical reference angle, and matching a second vertical angle with the second vertical reference angle, when the first angle is the first vertical angle, and the second angle is the second vertical angle.

16. The method of claim 13, wherein the matching includes:
matching rotational angles with the rotational reference angle, when the first angle and the second angle are the rotational angles.

17. The method of claim 10, wherein the first reference reflector and the second reference reflector have a vertical distance of 500 mm or more and a horizontal distance of 700 mm or more between the first reference reflector and the second reference reflector, on the same plane.
